(19) United States
(12) Patent Application Publication
(10) Pub. No.: US 2003/0191710 A1
(43) Pub. Date: Oct. 9, 2003

(54) Invoice purchase order system

(76) Inventors: Theresa M. Green, Rowayton, CT (US); Robert Bugg, Suffern, NY (US); Michael F. Quinn, Pound Ridge, NY (US)

Correspondence Address: KILPATRICK STOCKTON LLP, 607 14TH STREET, N.W., SUITE 900, WASHINGTON, DC, 20005, US

(21) Appl. No.: 10/401,611

(22) Filed: Mar. 31, 2003

Related U.S. Application Data
(62) Division of application No. 08/743,728, filed on Nov. 6, 1996, now abandoned.
(60) Provisional application No. 60/011,440, filed on Feb. 9, 1996.

(51) Int. Cl. G06F 17/60

(52) U.S. Cl. 705/40

(57) ABSTRACT

An improved method and system for tracking and reconciling invoices and other payment devices, purchase orders and corresponding letters of credit is disclosed. In the system and method, information about the purchase orders and corresponding letters of credit received from the customer are compared against the performance of the manufacturer. Differences are identified automatically. Differences on the purchase order/SKU level are identified automatically and are used by the customer to determine the destiny of the order, control inventory, decide subsequent shipping, warehousing and pricing issues. The differences are communicated to the customer and may be used by the financial institution in deciding to authorize payment. Discrepancies are automatically identified and codified and are used by the customer and/or financial institution in deciding payment. Reconciliation information is also provided to the customer to aid in reconciling the customer's books in view of the plurality of purchase orders.

### FIELD OF THE INVENTION

This invention relates generally to systems and processes for processing purchase orders, and more particularly to a system and process for automatically tracking, reconciling and otherwise processing purchase orders and corresponding letters of credit.

### BACKGROUND OF THE INVENTION

In the international marketplace, it is common practice for a purchaser—such as a retailer—to issue a purchase order when contracting with a manufacturer to produce goods for the customer. Purchase orders contain a number of provisions including a delivery date, the quantity of the goods, specifications for the manufacture of the goods, and purchase price. In order to receive payment for the goods produced under these purchase orders, the manufacturer will issue an invoice. Often, in the international marketplace, a customer will have the need to issue many purchase orders for different products or to different manufacturers. It is often useful and/or necessary for the customer to work with a financial institution who will consolidate these purchase orders under a letter of credit. This letter of credit is extended to the customer, and guarantees payment, generally to the manufacturer. It should be understood that payment may be to a beneficiary other than the manufacturer. However, for the purpose of this description, the manufacturer will be the beneficiary/payee for the letter of credit.

The letter of credit is thus the key interface between the customer and the manufacturer. The letter of credit stipulates submitting documents of compliance by the manufacturer in order to receive payment of an invoice from the financial institution. For example, the manufacturer may be required to show a bill of lading, an invoice and a certificate of origin showing where the goods originate, and/or an inspection certificate. Upon presentation to the financial institution of the documents required by the letter of credit, the customer is debited and the manufacturer (or beneficiary of the letter of credit) is paid. In this way letters of credit assure manufacturers (or beneficiaries)—who are often in countries different from that of the customers—that the payment of funds are available and will be paid if the delivery of the goods conforms to the terms of the letter of credit. Letters of credit therefore represent a valuable tool in conducting international trade. Procedures which are generally internationally recognized for handling letter of credit are set forth in various manuals and reference books including the Uniform Customs and Practices.

There is frequently a great deal of paperwork involved with international trade transactions—only a portion of which relates directly to the letter of credit. Tracking the paperwork, which is essential for proper receipt of goods and payment therefore, for the international transactions can be difficult, time consuming and expensive. Historically, banks have not concerned themselves with information ancillary to the letter of credit but rather have limited their involvement to the information and documents directly pertaining to the letters of credit. Accordingly, users of letters of credit, the customers, have limited the amount of information provided to the bank about the transaction because such information was considered excessive detail by the bank and is not required by the Uniform Customs and Practices (UCP) governing the issuance of letters of credit. Traditionally, customers have communicated with manufacturers directly in matters not directly related to a letter of credit, with no involvement from the bank.

Large customers may have many different letters of credit with a bank. The bank, in cases where there are a large number of letters of credit, may lump a number of letters of credit together, assign a master letter of credit reference number to the group, thus organizing the transaction using the bank's reference number. This grouping creates a master letter of credit. When customers attempt to reconcile their purchase orders with invoices and letters of credit, the different groupings and numbers used by the customer, the bank, and the manufacturer makes reconciling accounts difficult. For example, customers wishing to know the status of a purchase order possessing only the purchase order number would have to: 1) call the bank to find the letter of credit and/or the bank reference number; 2) call the bank for an invoice number; and 3) call the bank to obtain the letter of credit and bank reference number for the invoice.

Therefore, there is a need in the industry for a financial institution, such as a bank, to provide purchase order information to the customer coordinated with the letter of credit, and the manufactures' invoicing.

Further, the correlation of the documents presented by the manufacturer in compliance with the letter of credit is largely manual and is an expensive, time-intensive undertaking for the bank. There is a need in the industry for an improved method to input compliance documentation in a standard manner so that the review is done as efficiently and as verifiably as possible.

Further, because historically banks were only involved with the issuance of letter of credit in a transaction, extensive communications between the customer and the manufacturer may have been required for ancillary items. Accordingly, there is a need in the industry for banks to have a greater involvement in order to standardize the information available to the customer and the manufacturer. This includes information not necessarily related directly to the letter of credit. This would allow the customer to track the status of a purchase order and payment thereof, by making the flow of information more efficient and therefore provide a “value added” service to the customer. Further, there is a need for that information to be available as quickly as possible and preferably electronically.

### SUMMARY OF THE INVENTION

The applicants have created a system that facilitates the process described above through the use of an improved invoice purchase order tracking system and method. This system and method stores purchase order data in a database, and associates this data with the letters of credit issued by the financial institution. The letter of credit format issued by the financial institution includes a reference to the purchase order and stockkeeping unit (“SKU”) that it covers. This association allows for the entry of and search for information related to either the purchase order or the letter of credit.

The system operates as follows. First, the customer issues a number of purchase orders. The purchase orders are then grouped under a letter of credit. The data from the purchase orders is then entered into a computer, along with the letter of credit reference number provided by the financial institution, and is sent in structured message format to the electronic message center of the financial institution. This letter of credit number is a unique identifier for the issued letter of credit, it serves as a link to all other transactional data. The electronic message center is then accessed by a transaction processing system which reconciles the information to assure that the correct messages have been received and that the purchase order messages match the referenced letter of credit. If the reconciliation is successful, the purchase order messages are then stored in the invoice purchase order system database repository on a file server. Later amendments to the purchase orders, and/or letters of credit, flow in a similar manner through the system.

When the manufacturer seeks payment from the financial institution under the letter of credit by presenting documents required by the letter of credit (e.g., invoices, bills of lading, certificates of origin, inspection certificates), the details of these documents are entered into the invoice purchase order system from hardcopies by a representative of the financial institution. The system then automatically compares the data from the documents presented by the manufacturer to the delineations of the original purchase order and letter of credit. The system identifies differences automatically. For example, the number of goods specified in the purchase orders. These differences are identified as irregularities. The system automatically reports to the customer regarding the documentation presented by the manufacturer, including any irregularities. Thus, under this improved system the customer is automatically apprised of any irregularities. Thus, the customer has timely information that, for example, the goods have been shipped, that the correct amount has been shipped or that the manufacturer did not have access to the correct materials and therefore had to ship slightly different goods. This enables the customer to update their own internal system and reduces the number of inquiries that need to be placed to the manufacturer and/or the financial institution. These irregularities are fed back to the customer as informational data.

Before payment is made, a representative of the financial institution examines the documents presented by the manufacturer against the letter of credit to confirm that the terms and conditions of the letter of credit have been met by the manufacturer. The representative has access to the report described above including a listing of any irregularities. If the terms and conditions have not been met, then the financial institution's representative with the aid of the report identifies the problem, termed a discrepancy. Common discrepancies may include the bill of lading being too old or “stale,” or the documents were submitted by the manufacturer after the letter of credit has expired. In the event of such a discrepancy, the financial institution has to obtain approval from the customer before payment is (or can be) made. The customer, in turn, either approves payment notwithstanding the discrepancy, or negotiates with the manufacturer (beneficiary) outside the letter of credit.

Historically, the discrepancies were recorded as a text field in a database. Under this system, there was no way to track common discrepancies using the database. However, under the improved invoice purchase order system discrepancies are entered in a standard codified format. The purpose of this is to enable a user to track common discrepancies by code. This improved system enables the customer to not only approve or disapprove payment based upon a discrepancy but also to compile a history of discrepancies from a particular manufacturer. This history can be used by the customer to either evaluate and compare different manufacturers and/or as leverage when negotiating with a given manufacturer based on past performance.

Financial institutions traditionally made a single draw from a customer's account to honor a letter of credit that covered a number of purchase orders. Larger customers may have had a number of draws each day. A customer was then faced with the task of reconciling the various debits by the financial institution with all of the purchase orders corresponding to the debits. The possibility for errors and the need for follow-up was great.

The invoice purchase order system automatically provides the customer with a report which breaks down each debit into the various purchase orders covered by the debit. These purchase order debits are referenced by the customer's own reference identification that was previously stored in the repository. This detailed allocation of the debit for each purchase order enables the customer to automatically reconcile the debit with the appropriate accounts payable entry and thereby close the entries. Thus, manual reconciliation of debits to purchase orders may be eliminated altogether.

Further, in addition to the detailed allocation of the debit at the purchase order/SKU level, the invoice purchase order system also supplies the customer with the details of charges relating to procurement of the goods. Thus, the customer is able to identify all costs in procuring specific merchandise. This information supports pricing decisions enabling the customer to compete more effectively in the market place.

### BRIEF DESCRIPTION OF THE DRAWINGS

FIG. 1 is an overview of the integrated components and communications that comprise this Invoice Purchase Order System (often referred to as the “System” herein).

FIG. 2 is the beginning flow chart for operating the Invoice Purchase Order System, which is a method for monitoring international trade transactions. This, and the other diagrams, unless otherwise noted, depict the steps that a Trade Service Representative would take in logging into the System and operating it.

FIG. 3 diagrams the System Main Menu, which gives an overview of the Systems main functions.

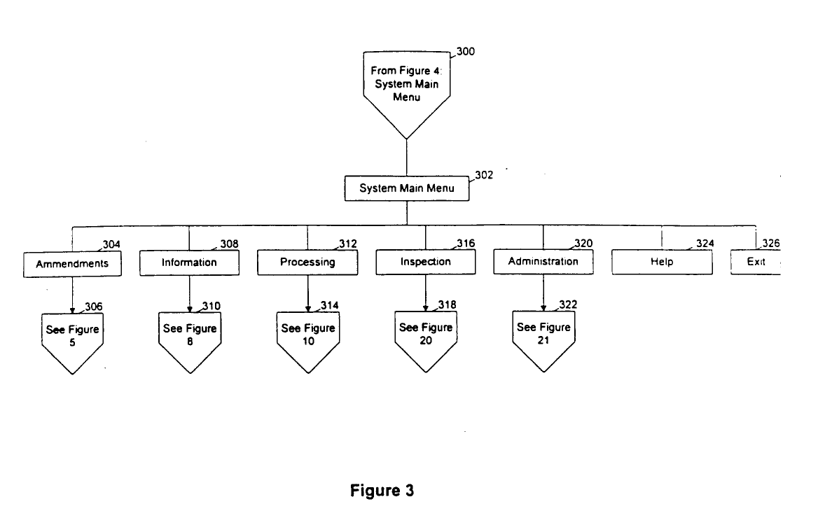

FIG. 4 diagrams the Start-of-Day Procedure used to initiate the System after shut down.

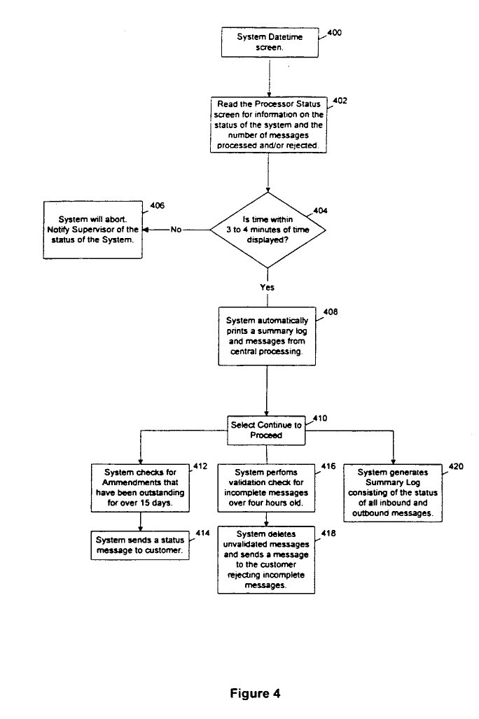

FIG. 5 diagrams the process of selecting Amendments.

FIG. 6 is a continuation of FIG. 5, and shows the procedure for processing a Letter of Credit (LC) Amendment.

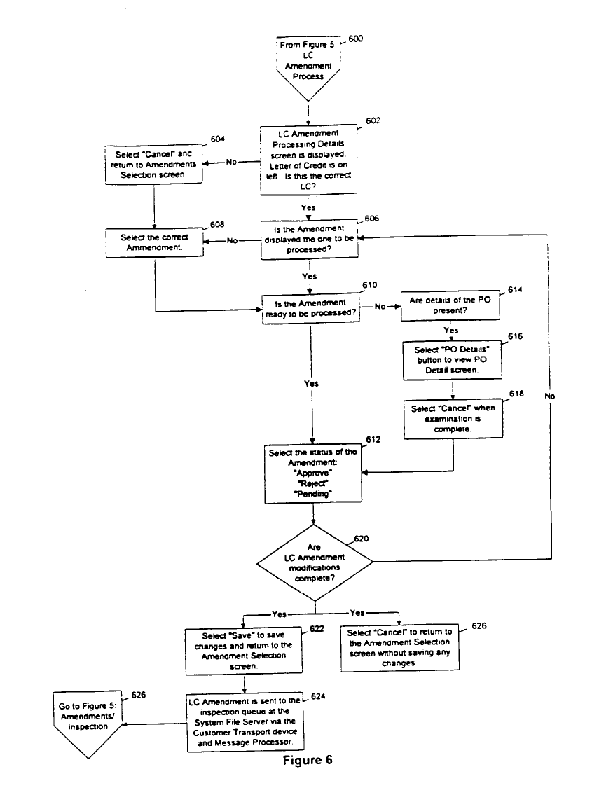

FIG. 7 is a continuation of FIG. 5, and shows the procedure for processing a Purchase Order (PO) Amendment.

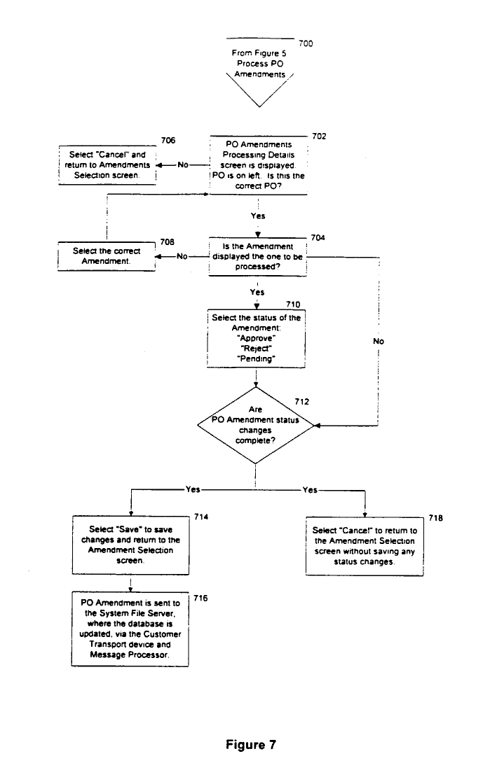

FIG. 8 shows the functions available under the Information menu of the System.

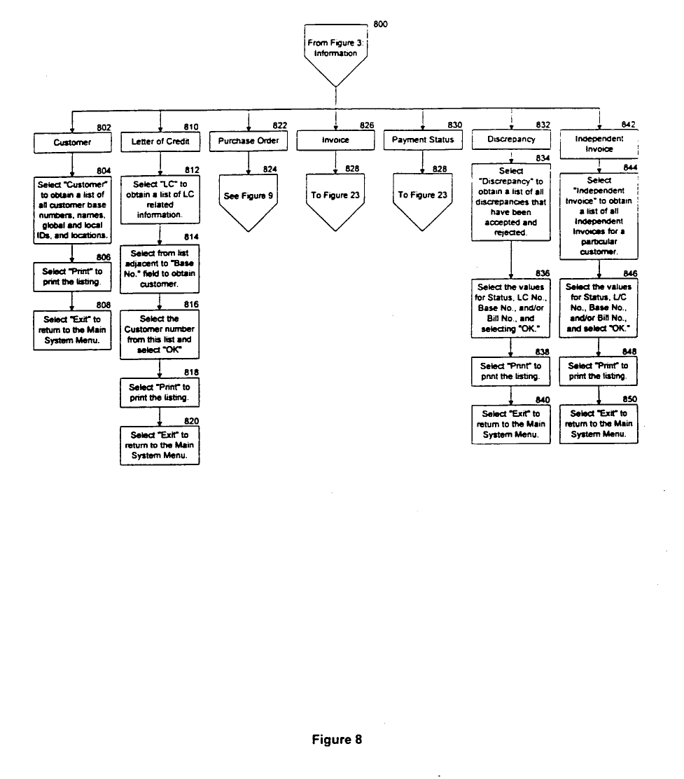

FIG. 9 is a continuation of FIG. 8 and delineates how to obtain information about a Purchase Order.

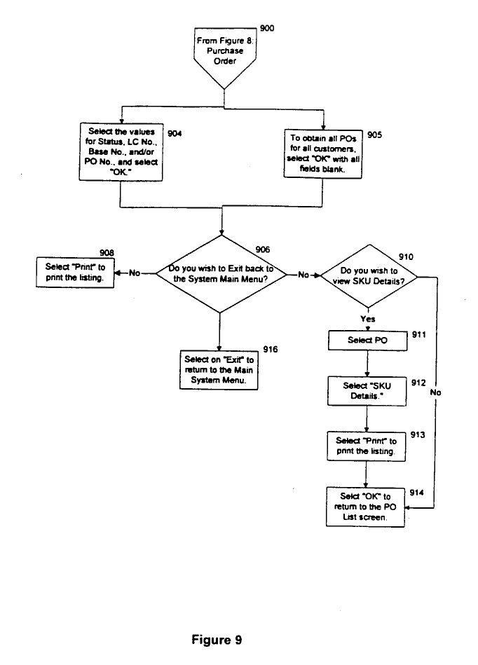

FIG. 10 diagrams the other processing options available under the System.

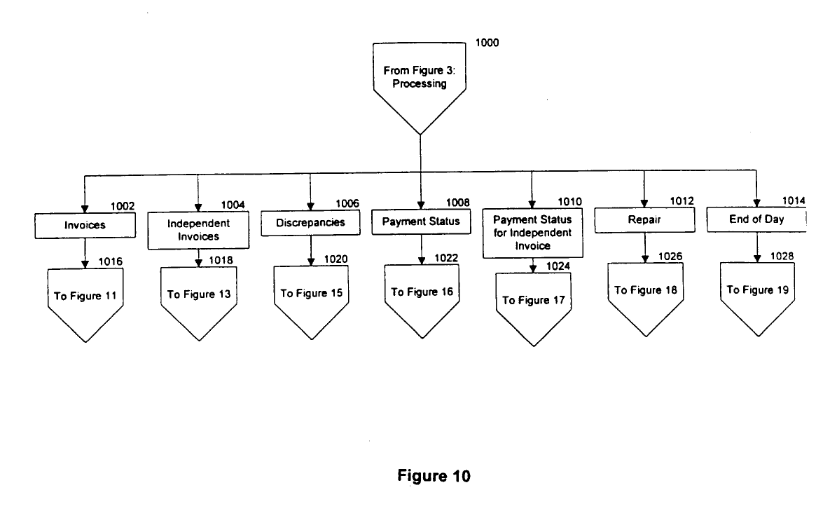

FIG. 11 diagrams the procedure for processing invoices.

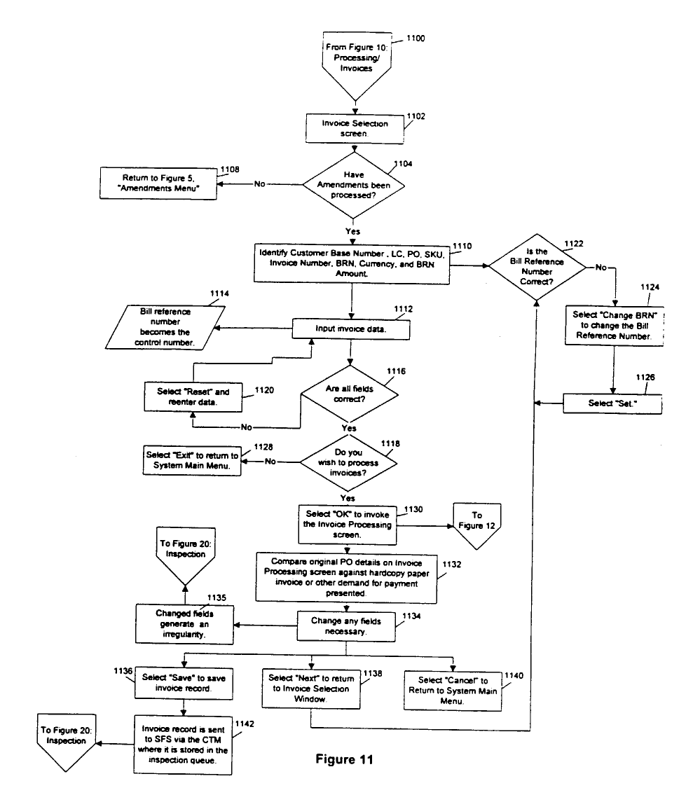

FIG. 12 depicts the options for obtaining information in the invoice processing area.

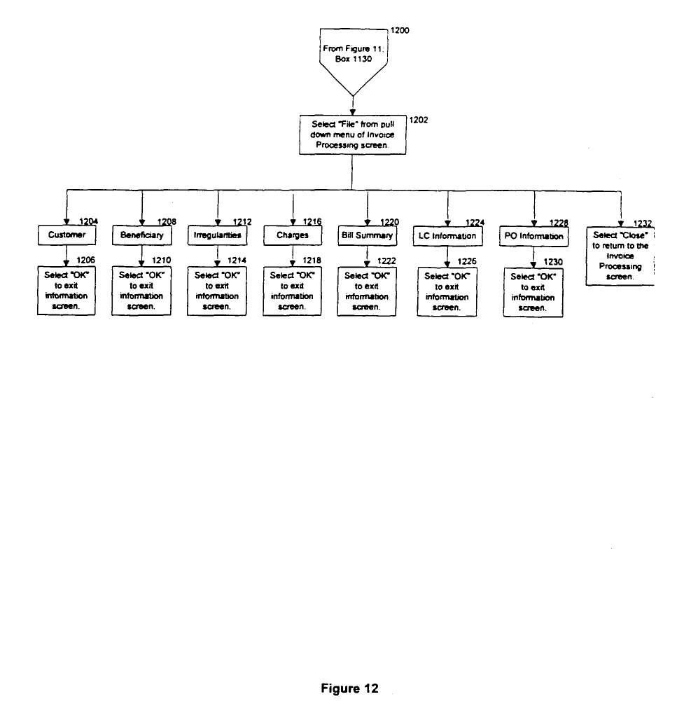

FIG. 13 diagrams the procedure for processing Independent Invoices.

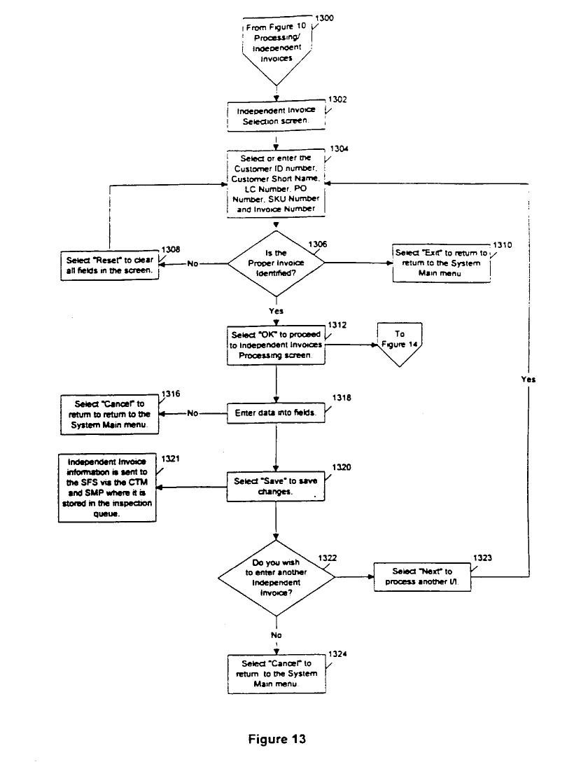

FIG. 14 is a continuation of FIG. 13 depicting the options for obtaining information in the processing of Independent Invoices.

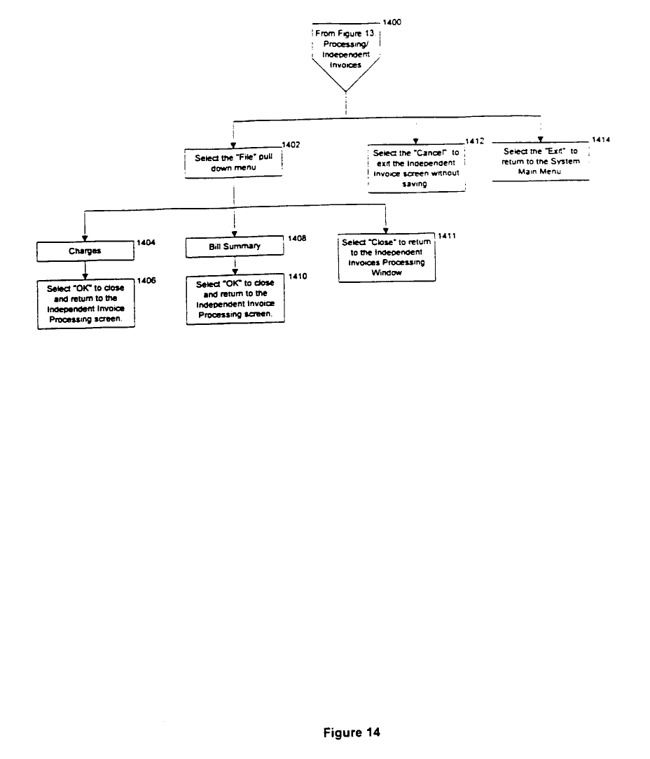

FIG. 15 diagrams the procedure for Processing Discrepancies.

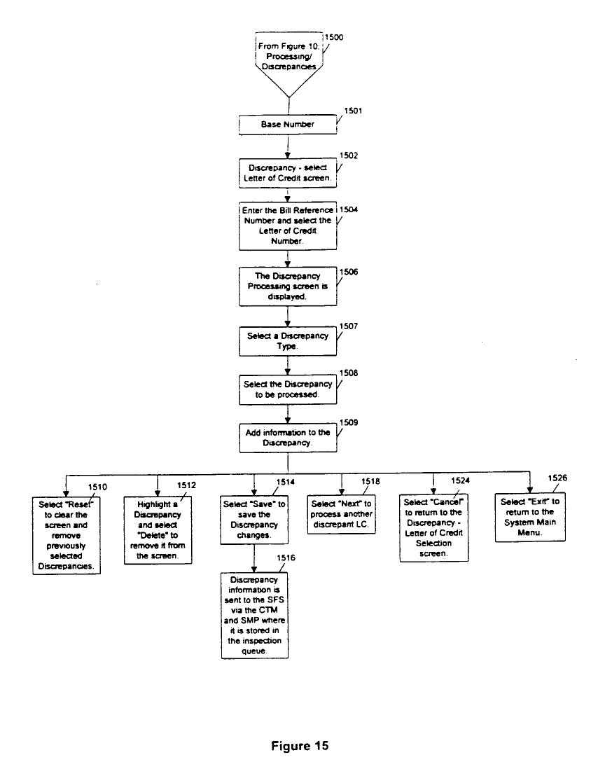

FIG. 16 diagrams the procedure for Processing Payment Status.

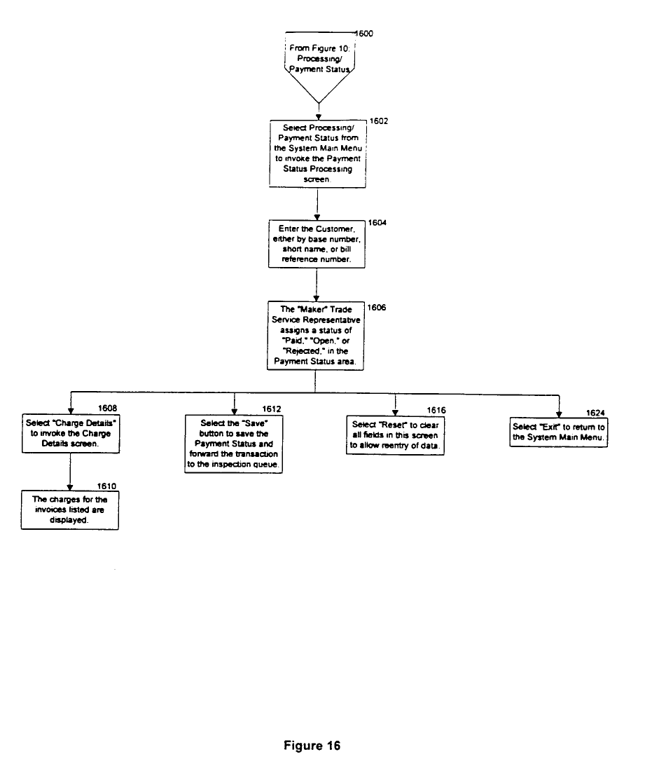

FIG. 17 diagrams the procedure for Processing Payment Status for Independent Invoices.

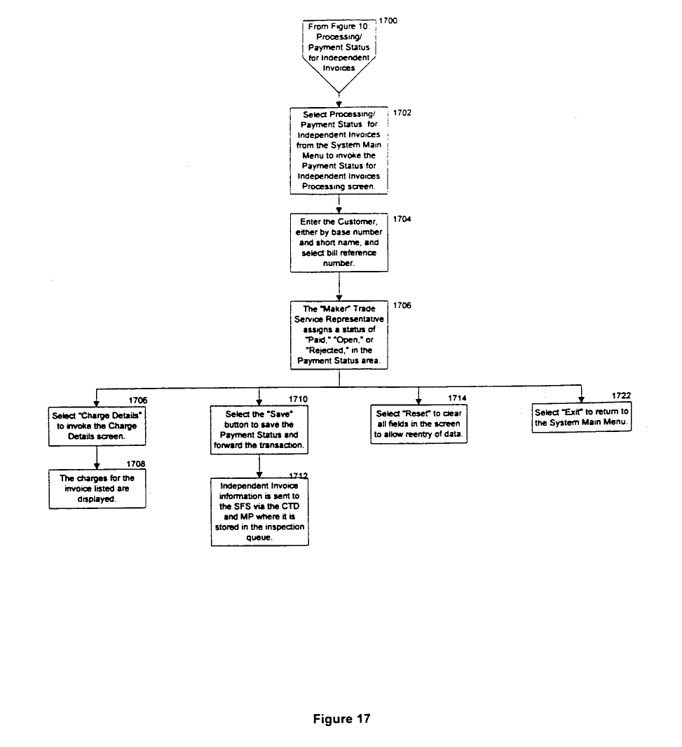

FIG. 18 diagrams the procedure for repairing Invoices or Discrepancies.

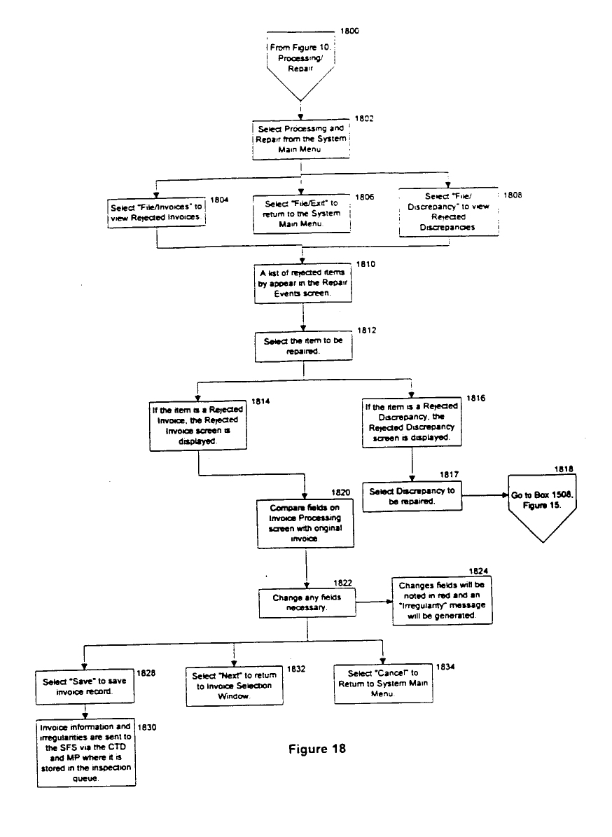

FIG. 19 diagrams the procedure for the End-of-Day Procedure.

FIG. 20 depicts the general options available in the System for inspecting instruments that have been entered into the System.

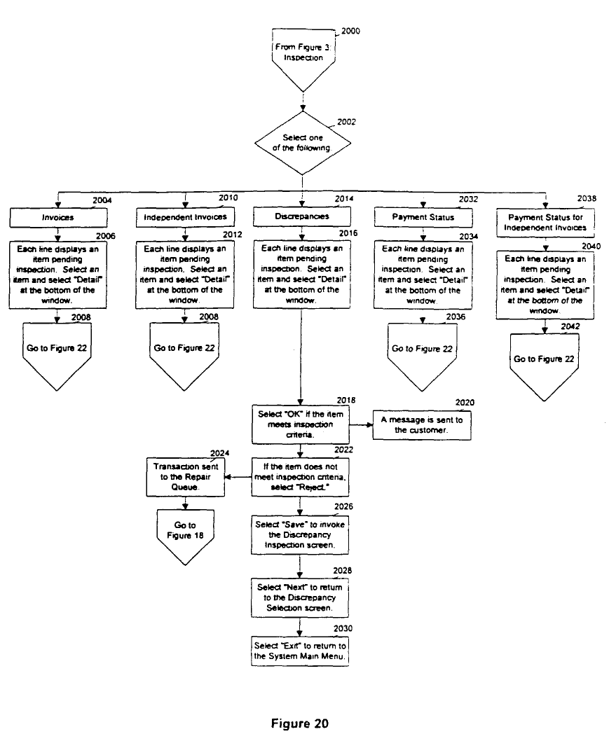

FIG. 21 diagrams the administrative capabilities of the System.

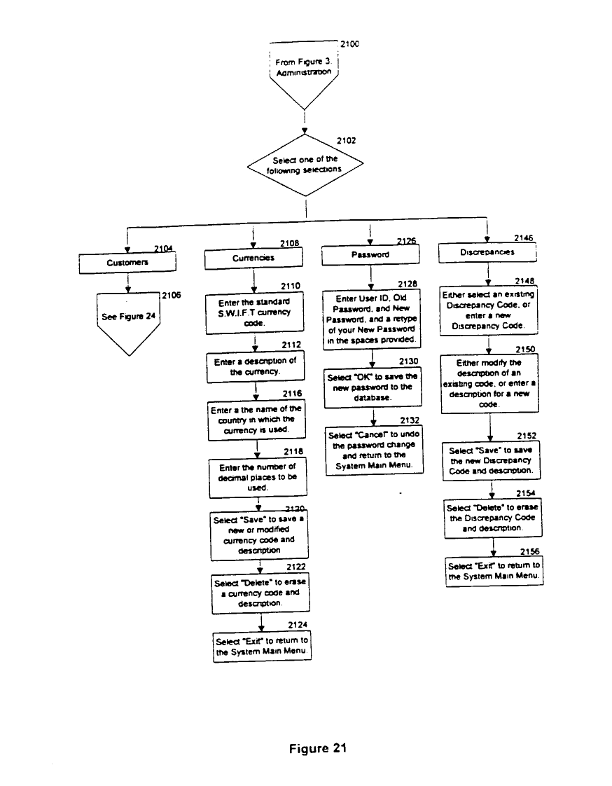

FIG. 22 is a continuation of FIG. 20, diagramming the procedure for inspecting specific instruments.

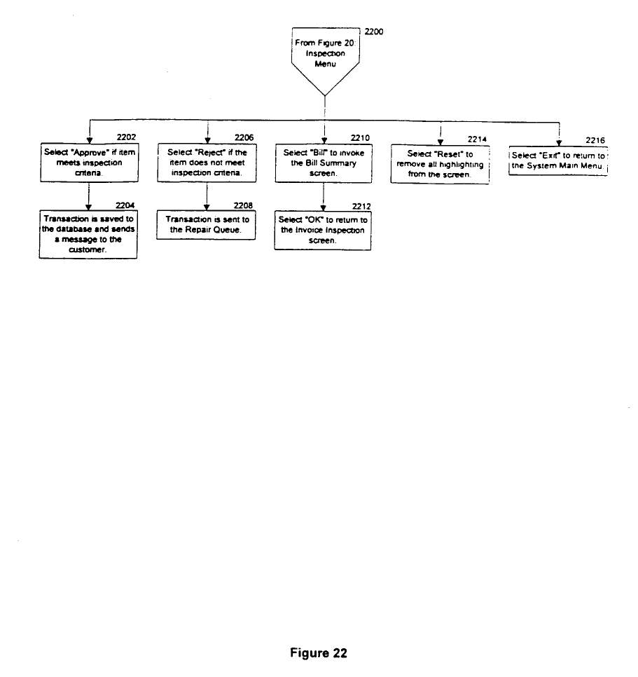

FIG. 23 is a continuation of FIG. 8, diagramming the step for obtaining information about Invoices or Payment Status.

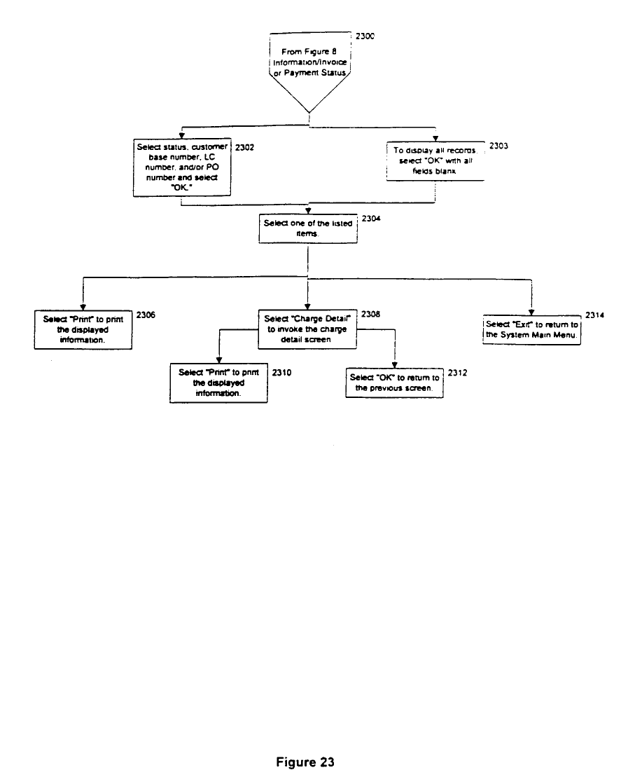

FIG. 24 is a continuation of FIG. 21, diagramming the procedure for adding, changing, or deleting customer information.

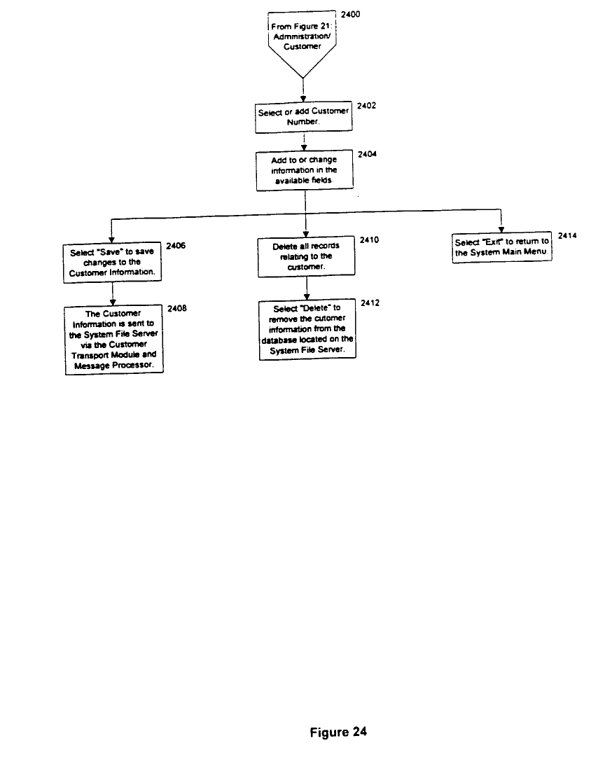

### DETAILED DESCRIPTION OF THE PREFERRED EMBODIMENT

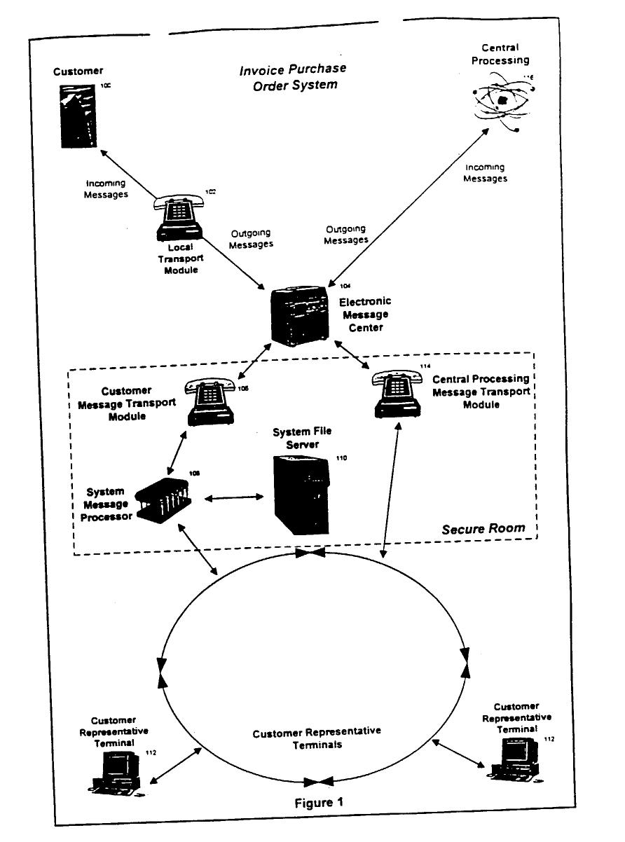

The system (FIG. 1) is a trade transaction information management system for importers and exporters. It provides a means for customers to forward, monitor and reconcile purchase orders against corresponding invoices. Transaction information is created by the customer (Block 100) or input by the Trade Service Representative (Block 112). The customer may send Letter of Credit (LC) applications, Purchase Order (PO) information, LC Amendments, PO Amendments and replies to Discrepancies.

This information is created in the customer environment. Where required, the customer information is converted to structured messages using software resident in the local personal computer housing the Local Transport Module (LTM) (Block 102). The messages are encrypted and sent via The Local Transport Module (Block 102) to the Electronic Message Center (EMC) (Block 104). The Customer Message Transport Module (CTM) (Block 106) retrieves the messages held in the EMC and through a “Handshake” routine passes the inbound messages to the System Message Processor (SMP) (Block 108).

The SMP validates the messages and checks for format integrity, completeness and corruption. Messages failing validation are rejected and deleted periodically and the customer notified of the condition by means of a status message generated by the SMP and sent to the EMC via the CTM. Once validated, the Message Processor passes the messages to the system file server (Block 110), which temporarily stores the message pending acknowledgment of issuance by the Central Processor.

Once on the SYSTEM FILE SERVER (Block 110) messages are sent to different areas. LCs, and LC Amendments that have been preliminarily processed, are sent back through the SMP to the Central Processing Message Transport Module (CPMTM) (Block 114). The CPMTM transmits the messages to the EMC (Block 104). The bank's Central Processing system (Block 116) retrieves the messages from the EMC (Block 104) and processes them. The LCs or LC Amendments are either approved (issued) or rejected. Central Processing transmits a message to the EMC where it is retrieved by the CPMTM and passed on to the SMP.

The SMP in turn, updates the system file server according to the status: issued LCs and Amendments are passed to the permanent data base; rejected transactions are deleted from the temporary file. At the same time the SMP passes the status condition on to the CTM (Block 106) to be sent to the EMC (Block 104). Status messages sent from the SMP are retained at the EMC until the customer retrieves the messages using their local Transport Module (Block 102).

POs and PO Amendments are similarly entered. PO information is created by the customer (Block 100) into a local system. The customer groups several POs under an LC, creating a linked transaction. The local system either creates the linked messages, linking grouped POs to the LC, or uses the conversion software to format the linked information into structured messages. The messages are then sent via the local Transport Module to the EMC (Block 104) where they are temporarily stored awaiting retrieval from the CTM (Block 106).

Again, the CTM passes the messages through a Handshake routine to the SMP (Block 108). The SMP validates the messages, checking for format integrity, completeness and corruption. Validated messages are sent to the system file server (Block 110) where the PO information is stored pending notification of the LC or LC Amendment issuance by the Central Processing unit. Messages failing validation are rejected and deleted periodically and the customer notified of the condition by means of a status message generated by the SMP and sent to the EMC via the CTM.

Status messages retrieved from the CP (Block 116) through the EMC (Block 104) update the system file server. Issued LCs and LC Amendments move the POs from the temporary file to the permanent file in the server. LCs and LC Amendments failing issuance, update the system file server by deleting the failed POs from the temporary file. All status messages are forwarded from the SMP (Block 108) to the CTM (Block 106) to the EMC (Block 104) where they await retrieval by the customer's LTM (Block 102).

POs and PO Amendments are processed by the Trade Service Representatives (TSR) at the Customer Representative Terminal (Block 112) using the System Application Software (System). Invoice Processing against POs in the database is performed by the TSR acting as “Maker.” The “Maker” retrieves records from the database, works the record and returns it to the database with a flag indicating that the record is ready for inspection by another TSR called the “Checker.” The “Checker” (TSR) retrieves the record, inspects the work of the “Maker” and either approves the record or rejects it. The Maker/Checker feature ensures that the same person cannot perform both functions for the same record.

Rejected records are “flagged” as “rejected” and are once more available for either repair where they are once again processed by the “Maker” and inspected by the “Checker.” Approved records are “flagged” as “Transmitted” and are sent as messages through the SMP (Block 108) to the CTM (Block 106) to the EMC (Block 104) awaiting retrieval by the customer.

TSRs also use the System to enter Independent Invoices, report the Payment Status of Purchase Orders, detail Charges at the Invoice level and advise of LC Discrepancies using a codified format. All information is processed by a Maker and inspected by a Checker. The System converts the inspected records into structured messages that are sent through the SMP to the CTM to the EMC (Block 104) where they await retrieval by the customer.

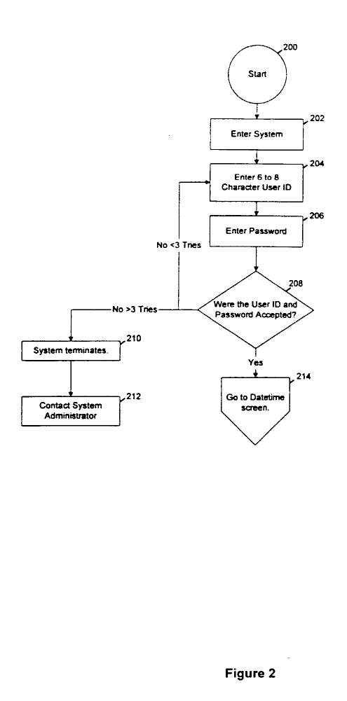

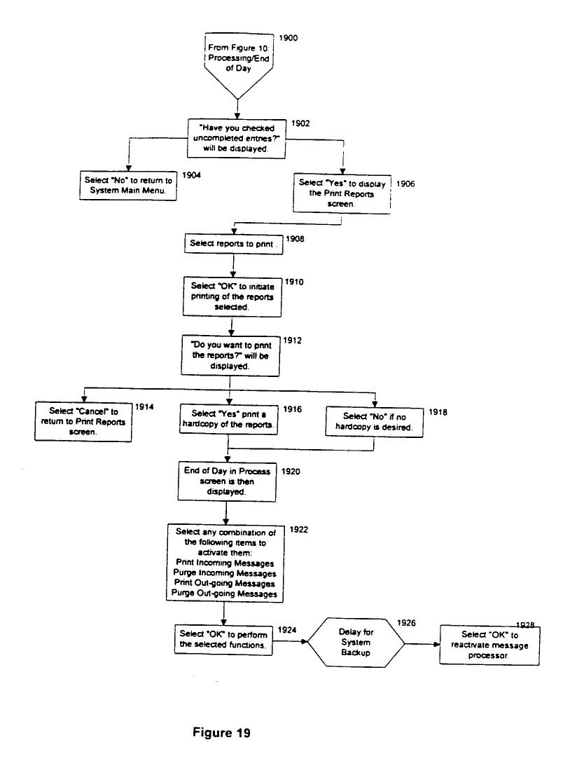

The functioning of the Invoice Purchase Order System (System)(FIG. 1) is symbolically flow charted starting with FIG. 2 at Block 100. The TSR starts (Block 200) by entering the System (Block 202)through a computer terminal that is connected to the System network. The computer may be any IBM compatible personal computer with a 486/66 Processor or above. The first screen to appear is the login screen. The user is prompted for a User ID (Block 204) and Password (Block 206). The User ID is 6 to 8 characters in length. If the password that has been entered is incorrect, the System will prompt the user to reenter the password. If the Password is entered unsuccessfully 3 times, the System will terminate(Block 210). In this case, the user must contact the System Administrator (Block 212) to reinstitute the privileges of the user. If the User ID and Password are correct, and it is the first login since then End-of-Day procedure was run (Block 1900, FIG. 19) the Start-of-Day process will begin automatically. If the user is logging in at any other time, the System Main Menu will be displayed.

If it is the first login since the End-of-Day procedure was run, the user will be required to run a Start-of-Day. The Start-of-Day begins automatically after an End-of-Day has been run. The Start-of-Day begins with a screen recapping the status of the Message Processor (SMP), the number of inbound messages processed since the End-of-Day and the number of messages rejected since the End-of-Day. A warning message appears on the screen asking the user if the date and time are correct. This procedure ensures that the System clock coincides with the actual time. The screen will ask if the time displayed is within 3 to 4 minutes of the actual time (Block 404). If it is, the user selects “Yes” and continues. If it is not within 3 to 4 minutes, select “No.” The System will abort (Block 406). The user must then notify the supervisor of the problem. In this case, a System Administrator would have to reset the System clock prior to use of the system.

If the system time is within the tolerance the next screen advises the user that the Summary Log and inbound messages will be printed. The Summary Log contains new and rejected Messages. The Summary Log is automatically printed as are all inbound messages received since the End-of-Day procedure. The system then advises the user that Start-of-Day timestamp has been affixed. When the user clicks or enters <OK>, the system then moves the user to the Main Menu. These messages include LC Applications, LC Amendments, POs, PO Amendments, and Discrepancy replies. The System performs three functions automatically, once Continue has been chosen: checks for Amendments that have been outstanding for over 15 days (Block 412); checks for incomplete messages over four hours old (Block 416); and generates a log of all inbound and outbound messages (Block 420). If an Amendment has been outstanding for over 15 days, a status message is sent to the user (Block 414). In the case of a message that has been incomplete for over four hours, the System deletes the incomplete messages and sends a message to the Customer rejecting the incomplete messages Block 418). Once these functions have been completed, the Start-of-Day procedure is finished. The System enters the System Main Menu (Block 300).

The System Main Menu (Block 302) is the originating point for all of the functions that the System performs. The System Main Menu provides the user with five choices of functions: Amendments (Block 304); Information (Block 308); Processing (Block 312); Inspection (Block 316); and Administration (Block 320). The System Main Menu also enables the user to obtain Help (Block 324) and to Exit from the System (Block 326). The user may select any of the above options from the System Main Menu.

The user would select Amendments to begin the processing of both LC Amendments and PO Amendments. In order to process either an LC or PO Amendment, the user selects the “Processing” pull down menu from the Amendments screen (Block 502). Under the Processing pull down menu, the user may choose either LC Amendments (Block 504) or PO Amendments (Block 514). LCs and LC Amendments can only be issued at Central Processing; no other users may issue LCs or LC Amendments. When either LC Amendment or PO Amendment is chosen for processing, the Amendment Selection screen is invoked. The user first selects a Base Number and then chooses an Amendment to process from the selections displayed (Blocks 506, 516). The user selects “Process” to invoke the Amendment Processing Details screen (Blocks 508, 518). From this screen, which is common to both LC and PO Amendments, the user processes the status of the amendment (Blocks 512, 522).

Amendment processing consists in reviewing the details of the amendment and assigning a “status” to the transaction event. The status of amendments can be “Accepted,” “Rejected” or “Pending.” Processing the status requires the work of both a Maker and a Checker. Under no circumstances can either the Maker or the Checker alter or input data into the Amendment Processing/Inspection screens.

When either an LC Amendment or a PO Amendment is chosen for processing, the Amendment Selection screen is invoked. The user must first choose the Customer Base Number before processing the amendment.

After choosing “Process” the system will display the original transaction on the left hand side of the screen and will display the related amendment on the right hand side of the screen. The user may scroll through multiple amendments for the selected base number. For each amendment reviewed, the Maker can “Approve,” “Reject” or “Pend” the amendment.

Once the status is applied, the TSR Maker exits the system. This action passes the Amendments reviewed by the Maker along with their Status to Inspection. At any time, if the user wishes to cancel the Review of Amendments, the user can select cancel and return to the Amendment Selection Screen.

If the LC Amendment also carries amendments to the underlying Purchase Order(s), the user may view the details of the PO Amendments by selecting PO Details. When selected, the PO Details are displayed with the Original Purchase Order information shown on the left hand side of the screen and the Amendment Details reflected on the right hand side of the screen. The LC Amendment information is then displayed on the screen to the right of the LC that it amends (Block 602). If this is not the correct LC, the user selects “Cancel” and return to the Amendment Selection screen (Block 504). Once the correct LC is selected, the user determines if the LC Amendment displayed is the one to be processed (Block 606) if it is not, the correct Amendment can be selected from a list (Block 608). The user determines if the LC Amendment is ready to be processed (Block 610). The user may wish to view details of the LC Amendment (Block 614) or (Block 620) prior to processing the status. If the user wishes to view details of the Amendment prior to processing, “PO Details” is selected (Block 616). Details are displayed on the screen. The user selects cancel when examination of the details is complete (Block 618).

Once the details of the LC Amendment have been examined the user may either Approve, Reject, or assign a status of Pending. This is done by selecting the corresponding status from the LC Processing screen (Block 612). This completes the processing to be performed. The user may save the changes by selecting “Save,” (Block 622). To cancel, select “Cancel” (Block 626) to exit without saving. If the user saves the changes, the LC Amendment Record is modified and the Record is sent back to the system file server, where it is stored pending inspection.

If the Amendment being processed is a PO, it may be processed from a CRT (Block 112). The PO Amendment information is then displayed on the screen to the right of the PO that it amends (Block 702). If this is not the correct PO, the user selects “Cancel” (Block 706) and returns to the Amendment Selection screen (Block 504). Once the correct PO is selected, the user determines if the PO Amendment displayed is the one to be processed (Block 704) if it is not, the correct Amendment can be selected from a list (Block 708).

The user may either Approve, Reject, or assign a status of Pending. This is done by selecting the corresponding status from the PO Processing screen (Block 710). The user determines if any further processing is necessary (Block 712). If this completes the processing to be performed the user may either save the changes by selecting “Save,” (Block 714) or select “Cancel” (Block 718) to exit without saving. If the user saves the changes, the PO Amendment is modified and the Record is sent back to the system file server, where it is stored.

To select an Amendment to be inspected, the user selects “Authorization” from the Amendments Menu and chooses either LC Amendments or PO Amendments (Block 524). Another Amendments Selection screen will be displayed. The user selects a Base Number and the respective Amendment to be Authorized and selects “Process” to invoke the Processing Details screens (Blocks 602, 702). The user may also select exit from the Amendments Menu to return to the System Main Menu (Block 552).

When the Approved PO Amendment is inspected, the PO Amendment Record updates the Permanent File of the system file server (Block 110) by moving the record from the Temporary File to the Permanent File. A Rejected PO Amendment, when inspected will delete the record and generate a status message through the SMP (Block 108) to the CTM (Block 106) to the EMC (Block 104) to the customer. Pending conditions do not move the record from the Temporary File in the system file server (Block 110).

The user may obtain information about Customers, LCs, POs, Invoices, Payment Status, Discrepancies, and Independent Invoices by selecting “Information” from the System Main Menu (Block 308). Selecting “Information” from the System Main Menu invokes the Information screen (Block 800).

In order to obtain information about a customer, the user selects “Customer” from the Information screen (Block 802). The Customer Information screen is displayed. To select All Records the user must click <OK>. To select Individual Records, the user selects a Base Number from the drop down listing available under the Base Number field on the screen. The screen displays the customer base number, the customer name, the global or local ID number, and/or the customer location (Block 804). The user can print the information displayed by selecting “Print” (Block 806) or return to the System Main Menu by selecting “Exit.” (Block 808)

To display information regarding an LC for a given customer, the user selects “Letter of Credit” from the Information screen. The LC Information screen is invoked.

To select All Records the user must click <OK>. To select Individual Records, the user selects a Base Number or an Individual LC Reference Number from the drop down listings available under the respective criteria fields on the screen.

All of the LCs for a given customer number are displayed (Block 812). The user selects the base number of the customer (Block 814) and selects <OK> in order to display its LCs (Block 816). The user may print the information displayed by selecting “Print” (Block 818) or return to the System Main Menu by selecting “Exit.” (Block 820)

Information regarding a PO is obtained by selecting “Purchase Order” from the Information screen (Block 822). To select All Records the user must click <OK>. To select Individual Records the user enters the LC No., Base No., and or PO No. (Block 904). Then selects <OK> to obtain information about a particular PO (Block 905). The user can print the information displayed by selecting “Print” (Block 908) or return to the System Main Menu by selecting “Exit” (Block 916). The user may obtain information regarding particular items ordered in the PO by highlighting a specific PO and selecting “SKU (Stock Keeping Unit) Details” from the PO List screen (Block 910). A screen containing detail about the items ordered is invoked. The user can print the information displayed by selecting “Print” (Block 913) or return to the Purchase Order List screen by selecting “Exit.” (Block 914)

The user may display Invoice Information by selecting “Invoice” from the Information screen (Block 826). Alternatively, this information can be displayed by highlighting the particular item listed and double clicking to display additional SKU details. To select All Records the user must click <OK>. To select Individual Records the user enters status, base number, LC, and/or PO number and selecting <OK> at the Invoice Selection screen (Block 2302). The user highlights an invoice from those listed (Block 2304). The user can print the information displayed by selecting “Print” (Block 2306) or return to the System Main Menu by selecting “Exit.” (Block 2314) The user can obtain a list of charges against the invoice selected by selecting “Charge Details” from the Invoice Information screen (Block 2308). Alternatively, this information can be displayed by highlighting the particular item listed and double clicking to display additional charges details. The user can print the information displayed by selecting “Print” (Block 2310) or close the screen by selecting <OK>. (Block 2312).

The user may display the payment status of invoices by selecting “Payment Status” from the information option of the Main Menu (Block 830). Invoices are displayed by entering status, base number, Bill Number, Invoice Number, LC, and/or PO number, and selecting <OK> at the Payment Status Information screen (Block 2302). The user highlights an invoice from those listed (Block 2304). The user can print the information displayed by selecting “Print” (Block 2306) or return to the System Main Menu by selecting “Exit.” (Block 2314) The user can obtain a list of charges against the invoice selected by selecting “Charge Details” from the Payment Status screen. Alternatively, this information can be displayed by highlighting the particular item listed and double clicking to display additional charges details. The user can print the information displayed by selecting “Print” (Block 2310) or close the screen by selecting <OK> (Block 2312).

The user may display Discrepancy Information by selecting “Discrepancy” from the Information option of Main Menu (Block 832). The Discrepancy List screen is invoked. It lists all Discrepancies that have been accepted and rejected (Block 834). To select All Records the user must click <OK>. To select individual records, Specific Discrepancies are selected by entering Status, Base number, LC, and/or Bill number and selecting <OK> at the Discrepancy List screen (Block 836). The user can print the information displayed by selecting “Print” (Block 838) or return to the System Main Menu by selecting “Exit.” (Block 840).

The user may display Independent Invoice information by selecting “Independent Invoice” from the Information option of the System Main Menu (Block 842). The Independent Invoice List screen is invoked. It lists all of the Independent Invoices for a particular customer (Block 844). To select All Records the user may click <OK>. To select Individual Records, Specific Independent Invoices are selected by entering Status, Base number, LC, and/or Bill number and selecting <OK> at the Independent Invoice List screen (Block 846). The user can print the information displayed by selecting “Print” (Block 848) or return to the System Main Menu by selecting “Exit” (Block 850).

The user may process Invoices, Independent Invoices, Discrepancies, Payment Status, Payment Status for Independent Invoices, execute Repairs to Records, and execute the End-of-Day sequence by selecting “Processing” from the System Main Menu (Block 312, Block 1000).

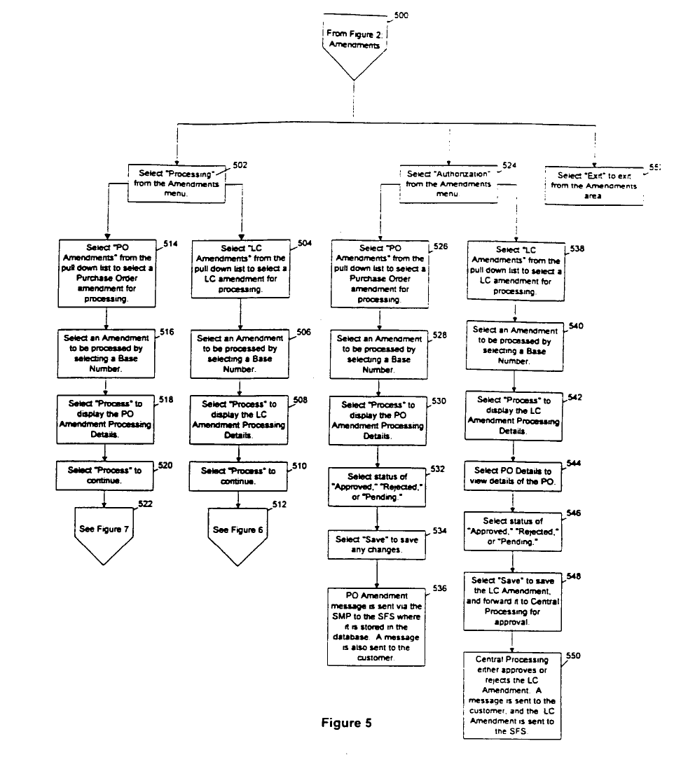

All amendments must be processed prior to processing invoices (Block 1104). For Amendment Processing see FIG. 5 starting at Block 500. To input invoice information, the Maker (user) selects the Customer Base Number, Related LC Reference, PO Reference and SKU Reference Number, then enters the Invoice Number. This action invokes the Bill Reference (BRN) Window (Block 1110). The user enters the Bill Reference Number, the Bill Date if the item is to be paid, the Currency and the Amount (Block 1112). When completed, the user then clicks on <OK> to move to the Invoice Processing screen (Block 1116). If there is an error upon invoice selection, the Maker selects “Reset” and reenters the Invoice Selection Data (Block 1120). At any time, the user may clear and reset the screen to re-input data by selecting “Reset.” The screen returns to the original information carried in the Purchase Order and the user can once again enter data into the respective fields.

After invoice selection data has been entered, invoices can be processed (Block 1118). If the user wishes to process invoices, <OK> is selected from the Invoice Selection screen (Block 1130), if not “Exit” is selected to return to the System Main Menu (Block 1128). Selection of <OK> invokes the Invoice Processing screen. The processing of an Invoice involves comparing the invoice data to the data of the PO to which it applies. The Invoice Processing screen displays the Bill Summary on the left of the screen, and the PO information is on the right of the screen. The Bill Summary shows the sum of the invoices that have been entered into the System under a given BRN. The user compares the original PO details on the Invoice Processing screen against a hardcopy paper invoice or other demand for payment presented (Block 1132). If any of the information does not coincide, the information fields in the PO Record are changed (Block 1134) by the user. Any of these changes will appear in red and an “Irregularity” will be created and automatically shown on the left hand side of the screen (Block 1135). Irregularities can also be viewed by selecting the “File” pull down menu from the Invoice Processing screen then selecting “Irregularities.” Once all data has been entered or changed correctly, the user selects “Save” to save the invoice record (Block 1136). “Save” saves the invoice record to the system file server, where it resides until recalled for inspection or re-processing. If the user does not wish to save the changes made to the invoice record, “Cancel” is selected, returning the user to the System Main Menu (Block 1140). To process another invoice after saving, the user selects “Next,” which returns the user to the Invoice Selection screen (Block 1138). If after completing input and saving the invoice, the user realizes that an incorrect BRN has been entered, the error can be corrected by reverting to the Invoice Selection Screen and selecting “Change BRN” (Block 1124). A new or another BRN can be applied to the selected invoice. The user selects “set” to replace the original Bill Reference Data with the changed Bill Reference Information (Block 1126).

The Invoice Processing screen has information categories available under the “File” pull down menu (Block 1202). The information topics are: Customer; Beneficiary; Irregularities; Charges; Bill Summary; LC Information; and PO Information. The Customer screen, chosen by selecting “File/Customer” from the Invoice Processing screen displays the name and address for the Customer associated with a given Base Number (Block 1204). Select <OK> to close the screen or select another option from the “File” menu to automatically close the current window (Block 1206). The Beneficiary screen, chosen by selecting “File/Beneficiary” from the Invoice Processing screen displays the name and address for the Beneficiary (Block 1208). Select <OK> to close the screen (Block 1210). The Irregularities screen, chosen by selecting “File/Irregularities” from the Invoice Processing screen displays a list of Irregularities generated in the processing of invoices (Block 1212). Select <OK> to close the screen (Block 1214). The Charges screen, chosen by selecting “File/Charges” from the Invoice Processing screen allows entry of any charges associated with a given invoice (Block 1216). Charges are entered as debits and discounts/adjustments/reversals are entered as credits in this screen (Block 1218). Select <OK> to close the screen. The user must “Save” the Invoice Record before the Bill Summary screen will be updated to reflect any charges input into the Charges screen. The Bill Summary screen, chosen by selecting “File/Bill Summary” from the Invoice Processing screen displays the total bill, the invoice plus charges, under the bill reference number (Block 1222). The Bill Summary also indicates the number of Invoices that have been entered, the number that have been inspected, and the number that remain to be inspected. Select <OK> to close the screen (Block 1222). The PO Information screen, chosen by selecting “File/PO Information” from the Invoice Processing screen displays amended or original PO Information (Block 1224). Select <OK> to close the screen (Block 1226). The LC Information screen, chosen by selecting “File/LC Information” from the Invoice Processing screen displays amended or original LC Information (Block 1228). Select <OK> to close the screen (Block 1230).

The System allows the user to process invoices for which there is no corresponding PO. These instruments are called “Independent Invoices (I/I).” I/Is can be entered and processed using the System. Select “Processing” from the System Main Menu (Block 312), then “Independent Invoices” from the Processing menu (Block 1004). This invokes the I/I Selection screen (Block 1302). After selecting the Base Number, enter data in the fields available (Block 1304). If the proper data has been enter select <OK> to save the data (Block 1306) and proceed to the I/I Processing screen (Block 1312). If the data has been entered incorrectly, select “Reset” to clear all fields, and reenter data (Block 1308). To return to the System Main Menu without saving, select “Exit” (Block 1310).

Processing I/Is involves entering I/I data Beneficiary information. Enter the applicable data fields (Block 1318). Select “Save” to save the changes to the I/I (Block 1320). When the I/I is saved, the I/I record message is sent to the system file server. To process another I/I select “Next” (Block 1323). This returns the user to the I/I Selection screen. To return to the System Main Menu without saving, select “Cancel” (Block 1324).

The I/I processing screen, like the Invoice Processing screen, allows the user to input information on Charges and the Bill Summary. The Charges screen, chosen by selecting “File/Charges” (Block 1402) from the I/I Processing screen allows entry of and displays any charges input with a given invoice (Block 1404). Charges are displayed as debit and discounts are entered as credits in this screen. Select <OK> to close the screen (Block 1406). The Bill Summary screen, chosen by selecting “File/Bill Summary” (Block 1402) from the I/I Processing screen displays the total bill, the invoice plus charges, under the bill reference number (Block 1408). The Bill Summary also indicates the number of Invoices that have been entered, the number that have been inspected, and the number that remain to be inspected. Select <OK> to close the screen (Block 1410). “Cancel” can also be selected from the I/I Processing screen to exit the I/I Processing screen without saving I/I information (Block 1412). “Exit” can be selected to return to the System Main Menu (Block 1414).

To process Discrepancies, select Processing from the System Main Menu (Block 312), then Discrepancies from the Processing pull down menu (Block 1006). This sequence invokes the Discrepancy Selection screen (Block 1502). The user selects the Base Number (Block 1501). The Discrepancy Selection screen is displayed. The user enters the BRN and selects the LC number at the top of the screen (Block 1504), this invokes the Discrepancy Processing screen (Block 1506). From this screen Discrepancies associated with the LC number can be selected from any of the following categories by selecting the categories on the screen: LC, Draft, Invoice, Packing List, Bill of Lading, Insurance, Certificate, PO, and Other (Block 1507). A list of Respective Discrepancies will be displayed when any of the above categories is selected. The user selects a Discrepancy from the desired list (Block 1508) and changes or adds information to the Discrepancy fields (Block 1509).

Once information on Discrepancies has been added or changed in a satisfactory manner, select “Save” to save the changes to the Discrepancy (Block 1514). The changed Discrepancy message, sent to the system file server awaiting inspection, is stored until recalled for further processing (Block 1516). Select “Next” to process another discrepant LC (Block 1518). Delete a Discrepancy by highlighting the Discrepancy and selecting “Delete.” (Block 1512)

If the information was not entered in a satisfactory manner; select “Reset” to clear the screen of previously selected Discrepancies (Block 1510), select “Cancel” to return to the Discrepancy—Letter of Credit screen without saving (Block 1524), or select “Exit” to return to the System Main Menu without saving (Block 1526).

Processing of Payment Status can be performed using the System. Processing of Payment Status consists primarily of conveying to the customer the status of payments against POs and LCs. When a bill or invoice is paid, the payment is registered on the System. Thus the System supplies the customer with ongoing information pertaining to the status of payments. The Processing of Payment Status is executed beginning with the selection of Processing from the System Main Menu (Block 312, 1602), then selecting Payment Status from the pull down menu (Block 1008, 1602).

To process the Payment Status of a specific customer, select the customer, either by Base Number or Customer Short Name, and the BRN (Block 1604). The Maker may change the status of the bill based on documentation by selecting “Paid,” “Open,” or “Rejected” (Block 1606).

If the Payment Status changes are correct, the Maker selects “Save,” which saves the Payment Status (Block 1612). The Payment Status message is then sent to the system file server via the SMP (Block 1614).

If the Payment Status changes are incorrect, the user may select “Reset,” which clears all fields to allow data reentry (Block 1616). Also, the user may select “Exit” to return to the System Main Menu without saving (Block 1624).

Information about charges can also be viewed from the Payment Status Processing screen. The user may select “Charge Details” to view the charge Details for the invoice selected (Block 1608). In this screen, charges are entered as debits, and discounts are entered as credits (Block 1610). Click the right mouse button to close the Charges screen.

Similarly the processing of payments under I/I can be performed using the System. The Processing of Payment Status is executed beginning with the selection of Processing from the System Main Menu (Block 312, 1702), then selecting Payment Status from the pull down menu (Block 1008, 1702).

To process the Payment Status of a specific customer, select the customer, either by Base Number or Customer Short Name, and the BRN (Block 1704). The Maker may change the status of the bill based on documentation by selecting “Paid,” “Open,” or “Rejected.” (Block 1706)

If the Payment Status changes are correct, the Maker selects “Save,” which saves the Payment Status (Block 1710). The Payment Status message is then sent to the system file server pending inspection (Block 1712).

If the Payment Status changes are incorrect, the user may select “Reset,” which clears all fields to allow data reentry (Block 1714). Also, the user may select “Exit” to return to the System Main Menu without saving (Block 1722).

Information about charges can also be viewed from the Payment Status Processing screen. The user may select “Charge Details” to view the charge Details for the I/I selected (Block 1706, 1708). Click the right mouse button to close the Charges window.

Rejected invoices and Discrepancies are repaired on the System using the Processing Repair function. Select Processing from the System Main Menu (Block 312, 1802), then “Repair” from the Processing pull down menu (Block 1012, 1802). This invokes the Repair Events screen. Using the “File” pull down menu of the, select either Invoices (Block 1804) or Discrepancy (Block 1808) to view a list of rejected items. Select “File” from the pull down menu then “Exit” to return to the System Main Menu (Block 1806). When either “Invoices” or “Discrepancies” is selected, a list of rejected items is displayed in the Repair Events screen (Block 1810). The user then selects the item to be repaired (Block 1812). If the item chosen is a Rejected Discrepancy, the Rejected Discrepancy screen is displayed (Block 1816). The process for repair is identical to the original Processing Discrepancies from this point on.

When “Invoice” is selected at the Repair Events screen, the Invoice Repair screen is displayed (Block 1814). The Invoice Repair screen is the same as the Invoice Processing screen (Block 1132). The user compares the fields on the Invoice Repair screen to the original PO (Block 1820). If any of the information does not coincide, the information fields in the PO area are changed (Block 1822). Any of these changes will appear in red and an “Irregularity” will be created and automatically shown on the left of the screen (Block 1824). Irregularities can be viewed by selecting the “File” pull down menu from the Invoice Processing screen then selecting “Irregularities.” Once all data has been entered or changed correctly, the user selects “Save” to save the invoice record (Block 1828). “Save” saves the invoice record message to the system file server pending inspection (Block 1830). If the user does not wish to save the changes made to the invoice record, “Cancel” is selected, returning the user to the System Main Menu (Block 1834). To process another invoice after saving, the user selects “Next,” which returns the user to the Invoice Selection screen (Block 1832).

The user may also invoke the End-of-Day procedure from the Processing menu (Block 1014). The End-of-Day sequence must be performed at the end of each day. It ensures that all queues have been cleared and all messages processed correctly. The End-of-Day Procedure involves the following ten steps:

1. Call for the End-of-Day making sure that all users are logged off the System.

2. Select “Processing” from the System Main Menu (Block 312), then select “End-of-Day” (Block 1014). End-of Day suspends the System processor (SMP) during the time that the System backup is performed.

3. When End-of-Day is activated, generate the standard set of reports (Blocks 1908-1912).

4. Review the reports to determine whether there are any errors or problems associated with the day's events.

5. Have a System Supervisor sign off to guarantee that reports have been generated and reviewed for accuracy.

6. As soon as reports have been generated, activate the Purge function, if applicable (Block 1922).

7. Back up the day's processing on an external medium (e.g. tape) and store off-premise.

8. Generate the day's Activity Journal.

9. Verify that all steps have been performed.

10. Make sure that the processor is working prior to leaving.

Several of these End-of-Day steps are performed using the System. To initiate the End-of-Day sequence, select “Processing” from the System Main Menu (Block 312), then “End-of-Day” from the Processing pull down menu (Block 1014).

The screen displays the following message “Have you checked uncomplete entries?” (Block 1902). If the user has not checked uncomplete entries, “No” is selected and the user is returned to the System Main Menu to check queues (Block 1904). If the user has checked the queues, “Yes” is selected (Block 1906). This invokes the Print Reports screen. From this screen, the user may select from the following the reports to print: Transactions Sent; Outstandings; Items Expired; Invoice Registered; Paid Bill; Summary Log; Transactions Received; Items Pending Inspection; Items Purged; Open Bill; Summary Log and User Log. Any or all of the reports may be selected for printing (Block 1908). The printing of the Summary Log and the Audit Log is mandatory. Select <OK> to initiate the printing of reports (Block 1910). The following message is then displayed on the screen: “Do you want to print the reports?” (Block 1912). The user may select “Yes” to print hardcopies of the reports (Block 1916), “No” if no hardcopy is desired (Block 1918), or “Cancel” to return to the previous screen (Block 1914). After printing, the End-of-Day in Process screen is displayed (Block 1920). The user may select any or all of the following functions to be performed on the End-of-Day in Process screen: Print Incoming Messages, Purge Incoming Messages; Print Out-going Messages; Purge Out-going Messages (Block 1922). Select <OK> to perform the functions selected (Block 1924). After printing messages and purging messages, a System Backup is performed (Block 1926). When completed, the user clicks <OK> to reactivate the Message Processor (Block 1928). A time-stamp is affixed to the task and the screen will show the Message Processor is running.

All items created and saved under the Processing menu are performed by the Maker. The System creates a queue at the system file server of all processed items that have been saved by the Maker for the Checker to inspect prior to official approval. The Checker uses the Inspection menu to inspect. The System does not allow the same individual to be both Maker and Checker on a given item.

The Inspection menu is invoked by selecting “Inspection” from the System Main menu (Block 316). The Inspection menu displays the following selections for inspection: Invoices (Block 2004); Independent Invoices (Block 2010); Discrepancies (Block 2014); Payment Status (Block 2032); and Payment Status for Independent Invoices (Block 2038). Selection of any of these by the checker invokes a screen with a queue of items pending inspection. The Checker then initiates the inspections either in Batch or Detail Level. To inspect at the Batch Level, the Checker selects one or more items listed for inspection and selects “Save” to save the action and send the message(s) to the customer, or selects “Reject” to reject the transaction and return it to the Maker for correction. Selecting “Reset” clears the selection(s) and returns the screen to its original mode. To inspect at the Detail Level, the Checker selects an item displayed in the list and selects “Details” (Blocks 2006, 2012, 2016, 2034, and 2040). The methods for inspecting particular Invoices, Independent Invoices, Payment Status, and Payment Status for Independent Invoices are essentially the same. Once an item has been selected for inspection, the data on the screen is compared to a hardcopy of the transaction. If the details entered are consistent with those on the hardcopy, “Approve” is selected by the Checker (Block 2202), the message is saved to the database, and a message is sent to the customer (Block 2204). If the data displayed on the screen does not match the hardcopy data, the Checker selects “Reject,” (Block 2206) and the item is sent to the Repair queue (Block 2208). The Checker may also select “Bill” to review the Bill Summary screen (Block 2210). The Checker may exit from the Bill Summary screen by select <OK> (Block 2212). If the Checker wishes to deselect any items, “Reset” is selected (Block 2214). The Checker may also select “Exit” to return to the System Main Menu (Block 2216).

The method for inspection of Discrepancies differs marginally from this process in that it does not offer access to the Bill Summary screen. An LC is selected from the Discrepancy Inspection—Selection screen (Block 2016). When “Detail” has been selected (Block 2016), the Discrepancy Inspection—Detail screen is displayed. This screen displays a list of the Discrepancies. The checker compares the specific of Discrepancies items to the LC, if the Discrepancy is valid, <OK> is selected (Block 2018) and a Discrepancy notice is forwarded to the customer (Block 2020). If the Discrepancy is not valid, “Reject” is selected (Block 2022), and the Discrepancy is returned to the Repair Queue and the Maker for processing (Block 2024). “Save” may be selected to save the approvals and rejections and return to the Discrepancy Inspection screen (Block 2026). “Next” may be selected to return to the Discrepancy Selection screen without saving (Block 2028), and “Exit” may be selected to return to the System Main Menu without saving (Block 2030).

Administrative functions need to be performed in order to maintain the System. For security, access to all administration functions other than Passwords is restricted to a “Manager” User ID. To perform Administration functions, select “Administration” from the System Main Menu (Block 320). The Administration menu is used to: add or modify customer information; add or modify currency information; change passwords; add/modify to the Discrepancy Code table.

To either add or modify Customer information, select “Customer” from the Administration pull down menu (Block 2104). This invokes the Customer screen. Either enter or select a Customer Base Number (Block 2402). If the customer number is a new number, enter customer information into the available fields, if the customer record is an existing one, modify the entries in the field as required (Block 2404). Select “Save” to save the new customer or the changes to the existing customer information (Block 2406). The customer information is then sent to the system file server (Block 2408). A customer may also be deleted. In order to delete a customer, the Manager must first delete all records relating to the customer from the System (Block 2410). Once all of the records have been deleted, select a customer number at the Customer screen, then select “Delete” (Block 2412). This step deletes the customer from the database on the system file server. Once the Manager has completed altering customer records, “Exit” is selected to return to the System Main Menu (Block 2414).

Currencies can be added or deleted from the System. Select “Currencies” from the Administration pull down menu (Block 2108). Enter the standard 3-character S.W.I.F.T. currency code (Block 2110), a description of the currency (Block 2112), the name of the country in which the currency is used (Block 2116), and the number of decimal places to be used (Block 2118). Once this information has been entered, select “Save” to save the currency to the database (Block 2120), or “Delete” to erase the currency code and description (Block 2122). Select “Exit” return to the System Main Menu (Block 2124).

Passwords can be changed from the Administration menu. A password must be changed every 30 days, but no more often than once per day. A password may not be repeated until three intervening different passwords have been used. To change a password, select “Password” from the Administration pull down menu (Block 2126). This invokes the Change Password screen. The user enters the User ID, Old Password, the New Password, and then retypes the New Password in the fields provided (Block 2128). The user then selects <OK> to save the new password to the database (Block 2130), or “Cancel” to undo the password change and return to the System Main Menu (Block 2132).

Discrepancies, as discussed above, are deviations from the LC terms and conditions. Discrepancies have corresponding code numbers that are stored in the database. These codes are used not only to describe the Discrepancy, but to make the reporting of Discrepancies consistent and more practically accountable. Discrepancy codes can be added of modified using the Administration menu. To add or modify a Discrepancy code, select “Discrepancies” from the Administration screen (Block 2146). To modify an existing Discrepancy code, select a Discrepancy code. To enter a new code enter the new code in the Discrepancy Code field (Block 2148). Once a code has been selected, either modify the existing description or enter a new description (Block 2150). Select “Save” to save the modification or new code (Block 2152), “Exit” to return to the System Main Menu without saving (Block 2154), or “Delete” to erase the selected code from the database (Block 2156).

What is claimed is:

1. A method for tracking and reconciling a plurality of purchase orders between a customer and a manufacturer and a payment between a financial institution and a beneficiary pursuant to a letter of credit corresponding to said plurality of purchase orders comprising the steps of:
receiving electronically first data from said customer, said first data regarding said purchase orders and said letter of credit at said financial institution;
storing said first data in a repository associated with a processing system associated with said financial institution;
inputting second data from said manufacturer corresponding to the performance of said manufacturer pursuant to said purchase order;
comparing automatically by said processing system said first data against said second data to automatically identify a difference, if any, between said two sets of data;
generating automatically by said processing system a message identifying said difference and at least a portion of said second data;
sending electronically said first report from said financial institution to said customer;
making a payment to said beneficiary from said financial institution pursuant to said letter of credit and debiting an amount corresponding to said payment from an account of said customer at said financial institution;
dividing automatically by said processing system said payment amount into individual purchase order payment amounts, each said individual purchase order payment amount corresponding to a purchase order; and
providing electronically a second message to said customer containing each individual purchase order payment amount and said debit payment amount to enable said customer to reconcile the debit payment amount to the corresponding purchase orders.

2. The method of claim 1 wherein said financial institution is a bank.

3. The method of claim 1 wherein said first data includes purchase order reference numbers used by the customer, each reference number corresponding to a purchase order.

4. The method of claim 1 wherein more than one difference is identified in the comparing step and further comprising the step of:
identifying each difference by its corresponding purchase order in said first message.

5. The method reference number of claim 1 further comprising the step of:
identifying each said purchase order payment amount by its corresponding purchase order reference number in said second message.

6. The method of claim 1 wherein said step of generating automatically said first message further comprises the step of:
codifying automatically said difference and including said codified difference in said first message.

7. The method of claim 1 further comprising the step of:
authorizing payment pursuant to said letter of credit by an individual associated with said financial institution after said individual has reviewed said first message.

8. The method of claim 1 further comprising the step of:
negotiating payment under said letter of credit between said customer and said manufacturer after said customer has been made aware of said difference contained in said first message.

9. The method of claim 1 wherein said difference is taken from the group of:
the goods to be manufactured being made of a material which is out of specification;
the goods being made are fewer than the number required in the purchase order; and
the term of the purchase order having expired.

10. The method of claim 1 wherein said first data includes an SKU reference number used by the customer.

11. The method of claim 1 wherein said manufacturer is said beneficiary.

12. The method of claim 1 wherein said difference constitutes a discrepancy and including said discrepancy in said first message.

13. The method of claim 1 wherein said difference constitutes an irregularity and including said irregularity in said first message.

14. A system for tracking and reconciling a plurality of purchase orders between a customer and a manufacturer and a payment between a financial institution and a beneficiary pursuant to a letter of credit corresponding to said plurality of purchase orders comprising:
receiving means for receiving said first data from said customer said first data regarding said customer orders and said letter of credit at said financial institution;
storing means for storing said first data;
processing mean associated with said financial institution for processing said first data;
second data corresponding to the performance of said manufacturer pursuant to said purchase order being input into said processor means;
further processing means for automatically comparing said first data against said second data to automatically identify differences between said two sets of data;
further processing means for automatically generating a first message identifying said differences;
means for sending said first message to said customer;
payment means for making a payment to said beneficiary pursuant to said letter of credit and debit means for debiting an amount corresponding to said payment from an account of said customer at said financial institution;
further processing means for automatically breaking down said payment amount into individual customer order amounts each corresponding to a purchase order; and
means for sending a second message to said customer said second message containing said broken down information thereby enabling said customer to automatically reconcile the customer order amounts to the corresponding customer order.

15. The system of claim 14 wherein said financial institution is a bank.

16. The system of claim 14 wherein said first data includes purchase order reference numbers used by the customer, each reference number corresponding to a purchase order.

17. The system of claim 14 wherein more than one difference is identified and further wherein said first message identifies each difference by its corresponding order.

18. The system of claim 14 wherein said second message identifies each purchase order payment amount by its corresponding purchase order reference number.

19. The system of claim 14 wherein the processing means further includes codifying means for codifying each difference and including the codified difference in said first message.

20. The system of claim 14 further comprising:
an individual associated with said financial institution authorizing payment pursuant to said letter of credit after said individual has reviewed said first message.

21. The system of claim 14 wherein said manufacturer is said beneficiary.

22. A method for tracking and reconciling a plurality of SKU's between a customer and a manufacturer and a payment between a financial institution and a beneficiary pursuant to a letter of credit corresponding to said plurality of SKU's comprising the steps of:
receiving electronically first data from said customer, said first data regarding said SKU's and said letter of credit at said financial institution;
storing said first data in a repository associated with a processing system associated with said financial institution;
inputting second data from said manufacturer corresponding to the performance of said manufacturer to said SKU's;
comparing automatically by said processing system said first data against said second data to automatically identify a difference, if any, between said two sets of data;
generating automatically by said processing system a message identifying said difference and at least a portion of said second data;
sending electronically said first message from said financial institution to said customer;
making a payment to said beneficiary from said financial institution pursuant to said letter of credit and debiting an amount corresponding to said payment from an account of said customer at said financial institution;
dividing automatically by said processing system said payment amount into individual SKU payment amounts, each said individual SKU payment amount corresponding to a SKU; and
providing electronically a second message to said customer containing each individual SKU payment amount and said corresponding debit payment amount to enable said customer to reconcile the debit payment amount to the corresponding SKU's.

23. A system for tracking and reconciling a plurality of SKU's between a customer and a manufacturer and a payment between a financial institution and a beneficiary pursuant to a letter of credit corresponding to said plurality of purchase orders comprising:
receiving means for receiving said first data from said customer said first data regarding said customer orders and said letter of credit at said financial institution;
storing means for storing said first data;
processing means associated with said financial institution for processing said first data;
second data corresponding to the performance of said manufacturer pursuant to said SKU being input into said processor means;
further processing means for automatically comparing said first data against said second data to automatically identify differences between said two sets of data;
further processing means for automatically generating a first message identifying said differences;
means for sending said first message to said customer;
payment means for making a payment to said beneficiary pursuant to said letter of credit and debit means for debiting an amount corresponding to said payment from an account of said customer at said financial institution;
further processing means for automatically breaking down said payment amount into individual customer order amounts each corresponding to a SKU; and
means for sending a second message to said customer said second message containing said broken down information thereby enabling said customer to automatically reconcile the customer order amounts to the corresponding customer order.
